(19) United States
(12) Patent Application Publication
(10) Pub. No.: US 2009/0096150 A1
(43) Pub. Date: Apr. 16, 2009

(54) Tray Systems

(76) Inventors: Robert W. Cihan, Tempe, AZ (US); Melissa Roulette-Cihan, Tempe, AZ (US)

Correspondence Address: Stoneman Volk Patent Group, 3770 NORTH 7TH STREET, Suite 100, PHOENIX, AZ, 85014, US

(21) Appl. No.: 12/245,633

(22) Filed: Oct. 3, 2008

Related U.S. Application Data
(60) Provisional application No. 60/979,040, filed on Oct. 10, 2007.
(60) Provisional application No. 60/988,679, filed on Nov. 16, 2007.
(60) Provisional application No. 61/019,799, filed on Jan. 8, 2008.
(60) Provisional application No. 61/048,146, filed on Apr. 25, 2008.

(51) Int. Cl. B23Q 3/00

(52) U.S. Cl. 269/289 R

(57) ABSTRACT

A system relating to providing a cutting board/serving tray that: reduces wear on the cutting board peripheral edge and cutting knife surfaces; prevents cuts along a fluid retaining channel; and, provides for food to be prepared, cut and served on the same tray. In a preferred embodiment, such tray system provides at least a 4-way use combination including: at least one combination wherein the lower piece serves as a tray and the upper piece serves as a tray cover; at least one combination wherein the upper piece serves as a bowl and the lower piece serves as an ice container; at least one combination wherein the lower piece serves as a bowl and the upper piece serves as a bowl cover; and at least one combination wherein the upper piece serves as a tray and the lower piece serves as an ice container.

### CROSS-REFERENCE TO RELATED APPLICATIONS

The present application is related to and claims priority from prior provisional application Ser. No. 60/979,040, filed Dec. 10, 2007, entitled “TRAY SYSTEMS”, and is related to and claims priority from prior provisional application Ser. No. 60/988,679, filed Nov. 16, 2007, entitled “TRAY SYSTEMS”, and is related to and claims priority from prior provisional application Ser. No. 61/019,799, filed Jan. 8, 2008, entitled “TRAY SYSTEMS”, and is related to and claims priority from prior provisional application Ser. No. 61/048,146, filed Apr. 25, 2008, entitled “TRAY SYSTEMS” the contents of all of which are incorporated herein by this reference and are not admitted to be prior art with respect to the present invention by the mention in this cross-reference section.

### BACKGROUND

This invention relates to providing a system for a combination cutting board and serving tray. More particularly, this invention relates to providing a cutting board/serving tray system that: reduces wear on the cutting board peripheral edge and cutting knife surfaces; prevents cuts along a fluid retaining channel; and, provides for food to be prepared, cut and served on either the top or bottom sides of the tray.

Cutting boards are often used to provide a surface for a user to prepare food. Food preparation often involves cutting the food. Typically, cutting boards are planar and of equal height throughout. One of the problems with planar cutting boards is that as a user cuts through a respective food, the knife also contacts the cutting board peripheral surface. In particular, when slicing, the knife often cuts across the periphery of the cutting board and, when cutting across a cutting board with a juice channel, may cause small grooves in the periphery of the juice channel that damage the cutting board (eventually permitting the juice to leave the channel and spill on off of the cutting board). Further, a knife tends to wear more as it cuts more; when having to cut through additional ancillary portions of the cutting board (as in the periphery) a knife will wear out more quickly. It would be highly useful to have a cutting board that would assist a user in more easily cutting through food and reducing knife wear and cutting board damage along the periphery. Even further, it would be useful to have a cutting board that can be used additionally as a serving tray, so that food may be prepared, cut and served on the same tray. Even further, it would be useful to have a cutting tray that could be utilized on both top and bottom sides with varied function on either side.

### OBJECTS AND FEATURES OF THE INVENTION

A primary object and feature of the present invention is to provide a system overcoming the above-mentioned problem.

Another primary object and feature of the present invention is to provide a tray system that provides a tray for both cutting and serving of food.

Another object and feature of the present invention is to provide a tray system that provides for fluid collection of juices that may collect during the cutting and preparation of food.

Another object and feature of the present invention is to provide a tray system that provides compartmented serving areas.

Another object and feature of the present invention is to provide a tray system that assists protecting the periphery of a tray while permitting cutting of food.

Another object and feature of the present invention is to provide a tray system that provides a cover to cover and store food both prior to serving and after serving.

Another object and feature of the present invention is to provide a tray system that provides a cover that can be placed beneath the cutting tray and used as a support base and assist holding cooling/heating elements or additional food product.

Another object and feature of the present invention is to provide a tray system that utilizes both top and bottom sides with varied function on either side.

Another object and feature of the present invention is to provide a tray system that provides at least four different use combinations.

A further object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a tray comprising: at least one first surface; at least one second surface; at least one third surface; and at least one support surface; wherein such at least one first surface is centrally located and situate at a highest elevation; wherein such at least one second surface is circumferential to such at least one first surface and situate at a lowest elevation; wherein such at least one third surface is peripheral to such at least one second surface and situate at an elevation intermediate to elevations of such at least one first surface and such at least one second surface; and wherein such at least one support surface is structured and arranged to support such at least one first surface in a substantially flat position. Moreover, it provides such a tray wherein: such at least one first surface permits slicing; such at least one second surface permits collection of at least one fluid; and such at least one third surface permits retaining of such at such at least one fluid.

Additionally, it provides such a tray wherein such at least one second surface comprises at least one channel structured and arranged to collect at least one material. Also, it provides such a tray wherein the elevation difference between such at least one first surface and such at least one third surface is at least about one-eighth inch and not more than about two inches. In addition, it provides such a tray wherein at least one periphery of such tray is substantially rectangular. And, it provides such a tray wherein such tray comprises HDPE plastic. Further, it provides such a tray wherein such at least one channel further comprises at least one divider structured and arranged to divide such at least one channel into at least two channel portions. Even further, it provides such a tray wherein such at least one channel comprises at least one pour spout structured and arranged to assist fluid removal from at least one of such at least one channel. Moreover, it provides such a tray further comprising at least one handle. Additionally, it provides such a tray wherein at least one periphery of such tray is substantially circular. Also, it provides such a tray further comprising: at least one lid; wherein such at least one lid is supportable by such at least one second surface.

In addition, it provides such a tray further comprising: at least one lid; wherein such at least one tray is supportable by such at least one lid. And, it provides such a tray wherein such at least one lid is structured and arranged to cover at least one portion of such at least one first surface. Further, it provides such a tray wherein such at least one handle comprises two such handles, one such handle opposed, with respect to such at least one support surface, to another such handle. Even further, it provides such a tray wherein such at least two handles comprise at least one serpentine connection edge intermediate of such at least two handles. Moreover, it provides such a tray wherein such at least one first surface is substantially flat. Additionally, it provides such a tray wherein such tray is structured and arranged so that a knife edge in place to slice upon such at least one first surface will not normally contact other portions of such tray. Also, it provides such a tray further comprising at least one channel filler structured and arranged to fill at least one such at least one channel.

In addition, it provides such a tray wherein such tray may be inverted comprising: at least one inverted first surface; at least one inverted second surface; and at least one inverted third surface; wherein such at least one inverted first surface is centrally located and situate at a lowest elevation; wherein such at least one inverted second surface is circumferential to such at least one inverted first surface and situate at a highest elevation; wherein such at least one inverted third surface is peripheral to such at least one inverted second surface and situate at an elevation intermediate to elevations of such at least one inverted first surface and such at least one inverted second surface; and wherein such at least one first surface is structured and arranged to support such at least one inverted first surface in a substantially flat position. And, it provides such a tray wherein: such at least one inverted first surface permits collection of at least one fluid; such at least one second surface permits slicing; and such at least one second surface permits retaining of such at such at least one fluid.

In accordance with another preferred embodiment hereof, this invention provides a method of using at least one tray, comprising at least one highest-elevation central cutting board portion, at least one lowest-elevation fluid-holdable channel portion, and at least one intermediate-elevation peripheral surface, comprising the steps of: situating sliceable food on the cutting board portion; using at least one knife to slice the food; arranging the food for presentation, wherein any fluids may collect in the channel portion; and carrying the tray with the food to at least one serving location.

In accordance with another preferred embodiment hereof, this invention provides a tray system, relating to providing at least one 2-piece tray ensemble comprising at least one tray piece and at least one tray-cover piece, wherein: each such at least one piece may be used upside or inverted; and by snap-connecting, at least four different-use combinations of such pieces are thereby provided. Further, it provides such a tray system wherein such at least four different-use combinations comprise: at least one combination wherein the lower piece serves as a tray and the upper piece serves as a tray cover; at least one combination wherein the upper piece serves as a bowl and the lower piece serves as an ice container; at least one combination wherein the lower piece serves as a bowl and the upper piece serves as a bowl cover; and at least one combination wherein the upper piece serves as a tray and the lower piece serves as an ice container.

### BRIEF DESCRIPTION OF THE DRAWINGS

FIG. 1 shows a perspective view, illustrating a cutting/serving tray of the tray system, according to a preferred embodiment of the present invention FIG. 1 FIG. 2 shows the sectional view 2-2 of FIG. 1.

FIG. 3 shows a top view, according to the preferred embodiment of FIG. 1.

FIG. 4 shows a perspective view, illustrating the tray system, according to another preferred embodiment of the present invention.

FIG. 5 shows a perspective view, illustrating another cutting/serving tray of the tray system, according to another preferred embodiment of the present invention.

FIG. 6 shows a side view of the preferred embodiment of FIG. 5.

FIG. 7 shows a top view of the preferred embodiment of FIG. 5.

FIG. 8 shows a perspective view you of a cover of the preferred embodiment of FIG. 5.

FIG. 9 shows a side view of a preferred embodiment of FIG. 8.

FIG. 10 shows a perspective view, illustrating the top side of another cutting/serving tray of the tray system, according to another preferred embodiment of the present invention.

FIG. 11 shows a perspective view, illustrating the bottom side of the cutting/serving tray, according to the preferred embodiment of FIG. 10.

FIG. 12 shows an exploded perspective view, utilizing a cover accessory of the cutting/serving tray, according to the preferred embodiment of FIG. 10.

FIG. 13 shows an exploded perspective view, utilizing a cover accessory of the cutting/serving tray, according to the preferred embodiment of FIG. 11.

FIG. 14 shows a side view, illustrating the cutting/serving tray, according to the preferred embodiment of FIG. 12.

FIG. 15 shows a top view, illustrating the cutting/serving tray, according to the preferred embodiment of FIG. 14.

FIG. 16 shows a sectional view through section 15-15 of FIG. 15.

FIG. 17A shows a perspective view, illustrating at least one use of a 4-way use of the cutting/serving tray, according to a preferred embodiment of the present invention.

FIG. 17B shows a perspective view, illustrating at least one use of a 4-way use of the cutting/serving tray, according to a preferred embodiment of the present invention.

FIG. 17C shows a perspective view, illustrating at least one use of a 4-way use of the cutting/serving tray, according to a preferred embodiment of the present invention.

FIG. 17D shows a perspective view, illustrating at least one use of a 4-way use of the cutting/serving tray, according to a preferred embodiment of the present invention.

### DETAILED DESCRIPTION OF THE BEST MODES AND PREFERRED EMBODIMENTS OF THE INVENTION

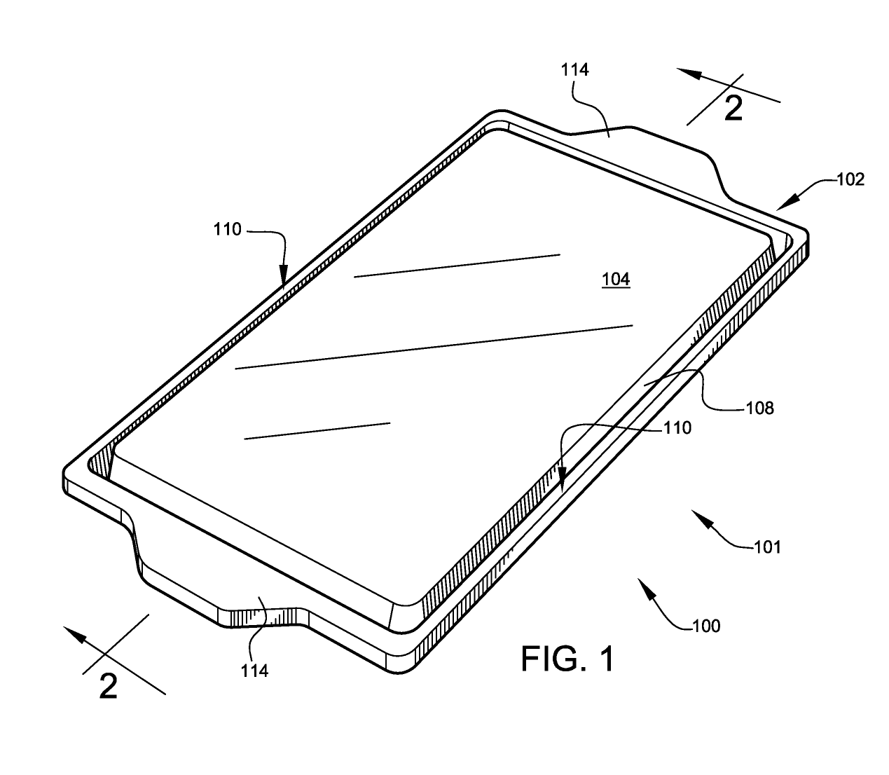

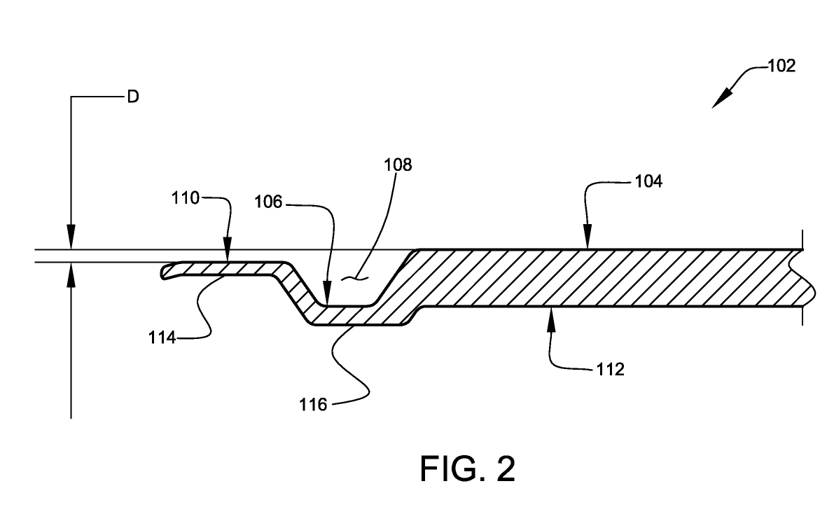

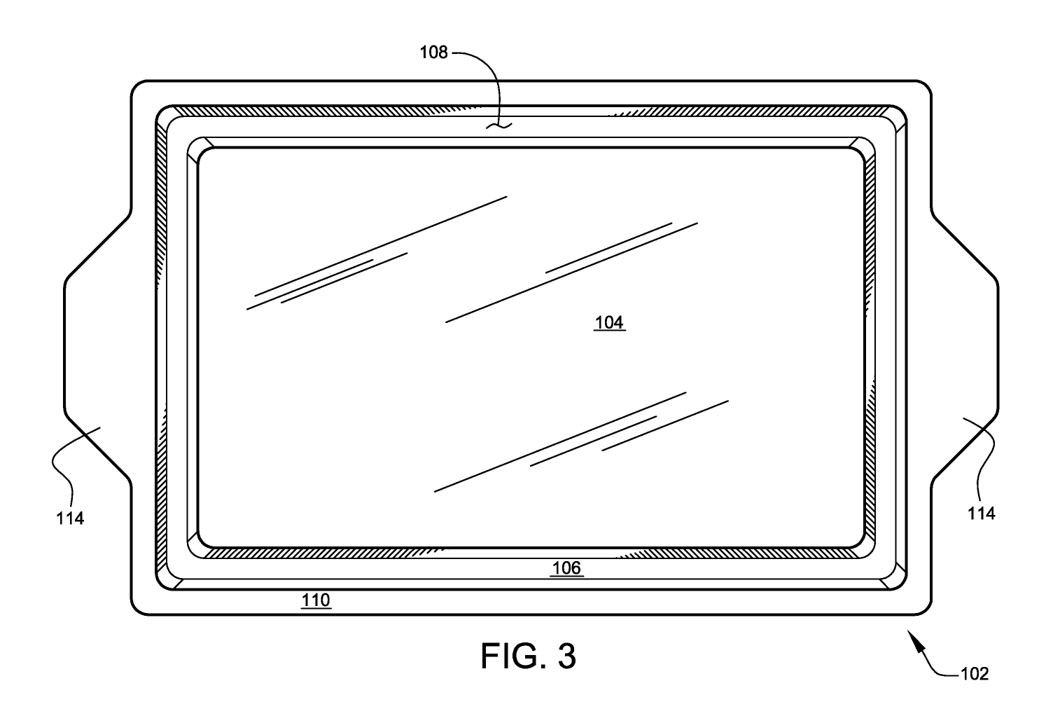

FIG. 1 shows a perspective view, illustrating a cutting board and serving tray 102 of the tray system 100, according to a preferred embodiment 101 of the present invention. FIG. 2 shows the sectional view 2-2 of FIG. 1. FIG. 3 shows a top view, according to the preferred embodiment 101 of FIG. 1.

Preferably, embodiment 101 comprises a combination cutting board and serving tray 102, as shown. Preferably, cutting board and serving tray 102 comprises three separate surface heights, as shown and described further herein. Preferably, cutting board and serving tray 102 comprises a first surface 104, preferably the largest surface, preferably centrally located and situate in the highest elevation of the three surfaces, as shown. Preferably, first surface 104 is substantially flat and provides a surface for cutting usable as a cutting surface for cutting foods with a knife. Preferably, first surface 104 may also be utilized as a serving surface for serving food, as shown. Upon reading this specification, those with ordinary skill in the art will now appreciate that, under appropriate circumstances, considering such issues as user preferences, marketing preferences, cost, structural requirements, available materials, etc., other serving tray arrangements such as, for example, use of the cutting board area for serving whether the food was cut on the board or not, etc., may suffice.

Preferably, cutting board and serving tray 102 comprises a second surface 106 (as shown in FIG. 2), preferably below the first surface 104, as shown. Preferably, the second surface 106 is the bottom of a channel 108, preferably, the lowest elevation, preferably circumferential to the first surface 104, as shown. Preferably, channel 108 assists with the collection of fluid (juices) that may occur during cutting or preparation of food on the first surface 104 (cutting surface),as shown. Upon reading this specification, those with ordinary skill in the art will now appreciate that, under appropriate circumstances, considering such issues as user preferences, marketing preferences, cost, structural requirements, available materials, etc., other fluid collection arrangements such as, for example, multiple fluid channels, serpentine fluid channels, drain holes, etc., may suffice.

Preferably, cutting board and serving tray 102 comprises a third surface 110, preferably peripheral to the second surface 106, preferably acting as a fluid blocker/retainer to assist retaining fluid within the channel 108, as shown. Preferably, third surface 110 also acts as a decorative edge for the cutting board and serving tray 102. Preferably, the third surface 110 is situate at an intermediate elevation to the first surface 104 and the second surface 106, as shown. Preferably, the third surface 110 is below the first surface 104 so that as a user cuts in a normal fashion perpendicular to the cutting surface along the first surface 104, a knife blade does not come into contact with the third surface 110. Preferably, the distance D in elevation between the first surface 104 and the third surface 110 is between about one-eighth inch and about one-inch. Upon reading this specification, those with ordinary skill in the art will now appreciate that, under appropriate circumstances, considering such issues as design preferences, structural requirements, available materials, geographic location, etc., other elevations between the first surface (cutting) and third surface (peripheral edge) may suffice.

Preferably, the cutting board and serving tray 102 comprises a support surface 112, most preferably having at least one bottom surface 112 that will flatly support the cutting board and serving tray 102 and keep the food level while being cut and/or served. Preferably, bottom surface 112 may comprise support legs 116 and may comprise serpentine handle portions that act as both handles and support for the cutting board and serving tray 102, as shown. Upon reading this specification, those with ordinary skill in the art will now appreciate that, under appropriate circumstances, considering such issues as cost, structural requirements, available materials, etc., other bottom supports structures using materials such as, for example, legs, rails, bumps, etc., may suffice.

Preferably, the tray system 100 comprises at least one handle 114, most preferably, two handles 114, as shown. Upon reading this specification, those with ordinary skill in the art will now appreciate that, under appropriate circumstances, considering such issues as design preferences, marketing, cost, structural requirements, available materials, etc., other handle arrangements such as, for example, hand grips, hand-holds, hand rails, etc., may suffice.

Preferably, cutting board and serving tray 102 are made from a hardened material that will not easily cut or damage, preferably, HDPE plastic. Preferably, the cutting surface (first surface 104) may be more hardened than the fluid channel (second surface 106) or periphery (third surface 110). Upon reading this specification, those with ordinary skill in the art will now appreciate that, under appropriate circumstances, considering such issues as cost, structural requirements, available materials, etc., other materials such as, for example, other plastics, hardwoods, ceramics, etc., may suffice.

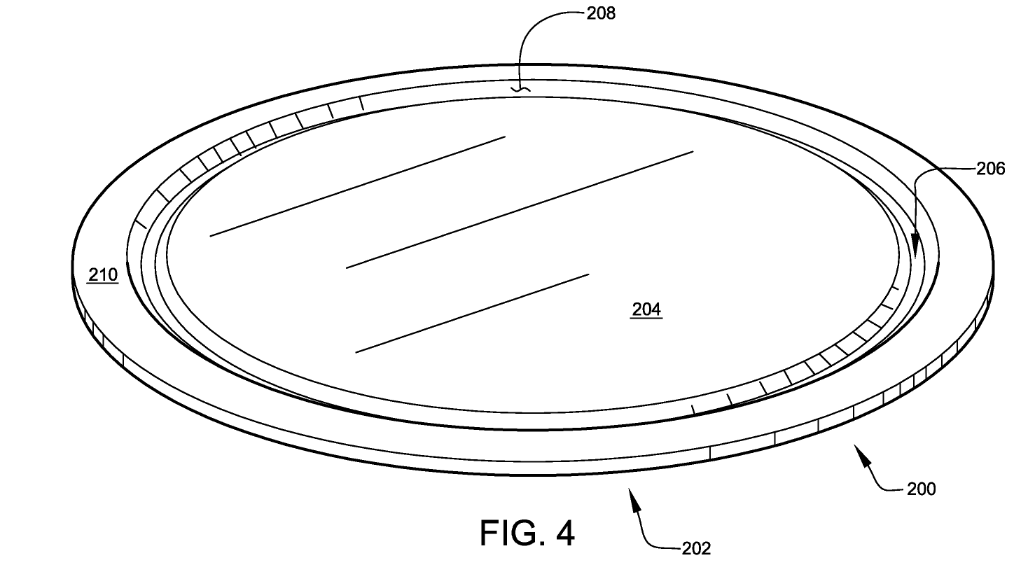

FIG. 4 shows a perspective view, illustrating the tray system, according to another preferred embodiment 200 of the present invention. Preferably, embodiment 200 comprises a combination cutting board and serving tray 202, as shown. Preferably, as described in embodiment 101, embodiment 200 comprises a cutting board and serving tray 202 having three separate upper surface heights, as shown.

Preferably, cutting board and serving tray 202 comprises a first surface 204, preferably the largest surface, preferably centrally located and situate at a highest elevation of the three upper surfaces, as shown. Preferably, first surface 204 is flat and usable as a cutting surface for cutting foods and as a serving surface for serving food, as shown.

Preferably, cutting board and serving tray 202 comprises a second surface 206, preferably below the first surface 204, as shown. Preferably, the second surface 206 is the lowest elevation and bottom of a channel 208 that is circumferential to the first surface 204. Preferably, channel 208 assists with the collection of fluid (juices) that may occur during cutting or preparation of food on the first surface 204 (cutting surface), as shown.

Preferably, cutting board and serving tray 202 comprises a third surface 210, preferably peripheral to the second surface 206, preferably acting as a blocker (fence) to keep fluid in the channel 208, as shown. Preferably, the third surface 210 is situate at an intermediate elevation to the first surface 204 and the second surface 206, as shown. Preferably, the third surface 210 is below the first surface 204 so that as a user cuts along the first surface 204, the knife blade does not come into contact with the third surface 210, as shown. Preferably, the distance D between the first surface 204 elevation and the third surface 210 elevation is between about one-eighth inch and about one-inch. Upon reading this specification, those with ordinary skill in the art will now appreciate that, under appropriate circumstances, considering such issues as design preferences, structural requirements, available materials, geographic location, etc., other elevations between the first surface (cutting) and third surface (peripheral edge) may suffice.

Preferably, the cutting board and serving tray 202 comprises a support surface 214, most preferably a flat bottom 212 that will flatly support the tray 202 and keep the food level while being cut and/or served. Upon reading this specification, those with ordinary skill in the art will now appreciate that, under appropriate circumstances, considering such issues as cost, structural requirements, available materials, etc., other bottom supports structures using materials such as, for example, legs, rails, bumps, etc., may suffice.

Preferably, cutting board and serving tray 202 is made from a hardened material that will not easily cut or damage, preferably, HDPE plastic, most preferably comprising both an anti-bacterial and a dishwasher safe material. Upon reading this specification, those with ordinary skill in the art will now appreciate that, under appropriate circumstances, considering such issues as cost, structural requirements, available materials, etc., other materials such as, for example, other plastics, hardwoods, ceramics, etc., may suffice.

Preferably, use of the tray system 100 described above provides a method of using the tray system 100 comprising the steps of: situating sliceable food on the cutting board portion; using at least one knife to slice the food; arranging the food for presentation, wherein any fluids may collect in the channel portion; and carrying the tray with the food to at least one serving location.

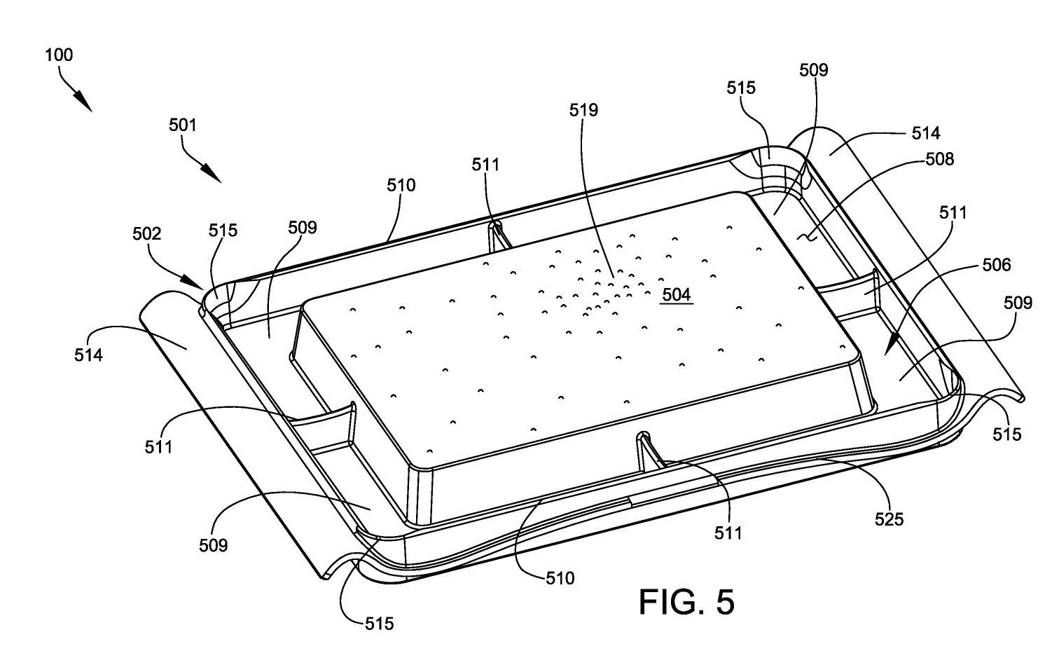

FIG. 5 shows a perspective view, illustrating another cutting/serving tray of the tray system 100, according to another preferred embodiment 501 of the present invention. Preferably, embodiment 501 comprises a combination cutting board and serving tray 502, as shown. Preferably, cutting board and serving tray 502 comprises three separate surface heights, as shown and described further herein. Preferably, cutting board and serving tray 502 comprises a first surface 504, preferably the largest surface, preferably centrally located and situate in the highest elevation of the three surfaces, as shown. Preferably, first surface 504 is substantially flat and provides a surface for cutting usable as a cutting surface for cutting foods with a knife. Preferably, the first surface 504 also comprises a texture 519, preferably dimpled and or textured, preferably assisting gripping of items to be cut and, preferably assisting maintaining a clean look for the first surface even after multiple uses cutting on the surface.

Preferably, first surface 504 may also be utilized as a serving surface for serving food, as shown. Upon reading this specification, those with ordinary skill in the art will now appreciate that, under appropriate circumstances, considering such issues as user preferences, marketing preferences, cost, structural requirements, available materials, etc., other serving tray arrangements such as, for example, use of the cutting board area for serving whether the food was cut on the board or not, etc., may suffice.

Preferably, cutting board and serving tray 502 comprises a second surface 506, preferably below the first surface 504, as shown. Preferably, the second surface 506 is the bottom of a channel 508, preferably, the lowest elevation, preferably circumferential to the first surface 504, as shown. Preferably, channel 508 assists with the collection of fluid that may occur during cutting or preparation of food on the first surface 504 (cutting surface), as shown. Additionally, the channel 508 is preferably compartmentalized, preferably quartered, as shown. Preferably, each compartment 509 is separated from each other respective compartment 509 by dividing wall elements 511, as shown. Preferably, the compartments 509 may be used to hold different fluid elements or different food elements that may be served with the cutting board and serving tray 502. Upon reading this specification, those with ordinary skill in the art will now appreciate that, under appropriate circumstances, considering such issues as user preferences, marketing preferences, cost, structural requirements, available materials, etc., other fluid collection arrangements such as, for example, multiple fluid channels, serpentine fluid channels, drain holes, etc., may suffice.

Preferably, each respective compartment 509 further comprises a fluid pour spout 515, as shown. Preferably, the fluid pour spout 515 is located in the corners 517 of the compartments 509 when the cutting board and serving tray 502 is rectangular in shape, as shown. When the cutting board and serving tray 502 is circular, the fluid pour spout 515 is preferably centered in the compartment 509. Preferably, the fluid pour spout 515 has a radius of about one inch, as shown.

Upon reading this specification, those with ordinary skill in the art will now appreciate that, under appropriate circumstances, considering such issues as user preferences, marketing preferences, cost, structural requirements, available materials, etc., other pour spout arrangements such as, for example, off center, smaller or larger radiuses, etc., may suffice.

Preferably, cutting board and serving tray 502 comprises a third surface 510, preferably peripheral to the second surface 506, preferably acting as a fluid blocker/material retainer to assist retaining fluid and material within the channel 508, as shown. Preferably, third surface 510 also acts as a decorative edge for the cutting board and serving tray 502. Preferably, the third surface 510 is situate at an intermediate elevation to the first surface 504 and the second surface 506, as shown. Preferably, the third surface 510 is below the first surface 504 so that as a user cuts in a normal fashion perpendicular to the cutting surface along the first surface 504, a knife blade does not come into contact with the third surface 510. Preferably, the distance in elevation between the first surface 504 and the third surface 510 is between about one-eighth inch and about one-inch. Upon reading this specification, those with ordinary skill in the art will now appreciate that, under appropriate circumstances, considering such issues as design preferences, structural requirements, available materials, geographic location, etc., other elevations between the first surface (cutting) and third surface (peripheral edge) may suffice.

Preferably, the cutting board and serving tray 502 comprises a support surface 512, most preferably having at least one bottom surface 513 that will flatly support the cutting board and serving tray 502 and keep the food level while being cut and/or served. Upon reading this specification, those with ordinary skill in the art will now appreciate that, under appropriate circumstances, considering such issues as cost, structural requirements, available materials, etc., other bottom supports structures using materials such as, for example, legs, rails, bumps, etc., may suffice.

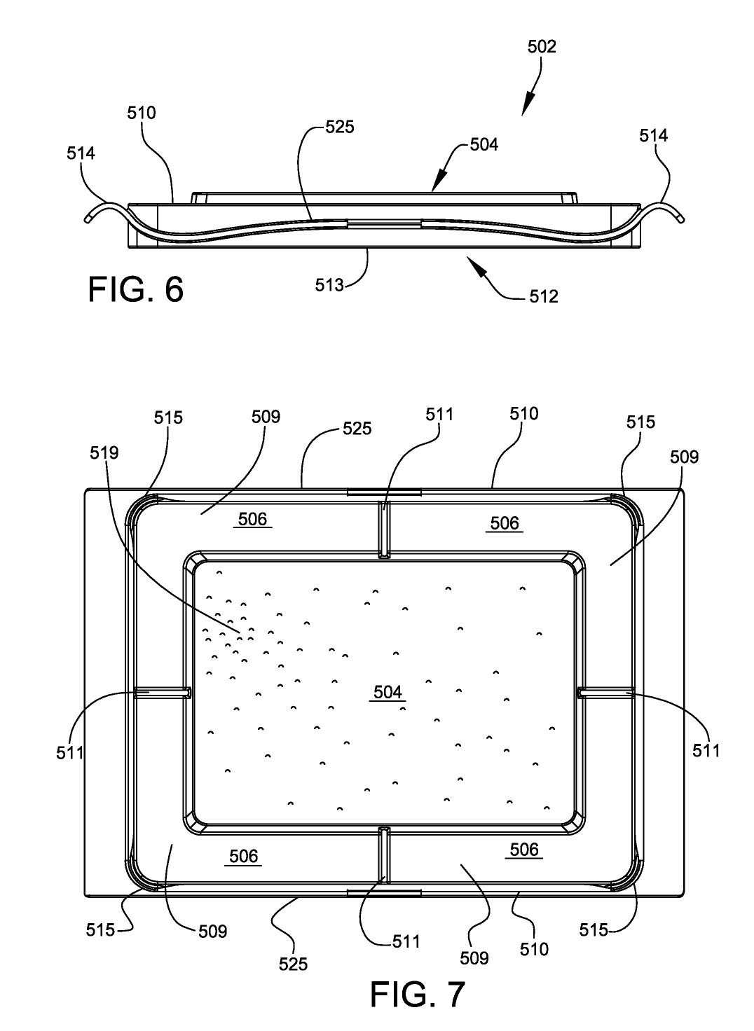

FIG. 6 shows a side view of the preferred embodiment of FIG. 5. FIG. 7 shows a top view of the preferred embodiment of FIG. 5. Preferably, the cutting board and serving tray 502 comprises two handles 514, as shown. Preferably, intermediate and connected to the two handles 514 are serpentine edging elements 525, as shown. Preferably, serpentine edging elements 525 assists a user in positioning the cutting board and serving tray 502, catch fluid that may drip when serving, and provide a decorative edge, as shown.

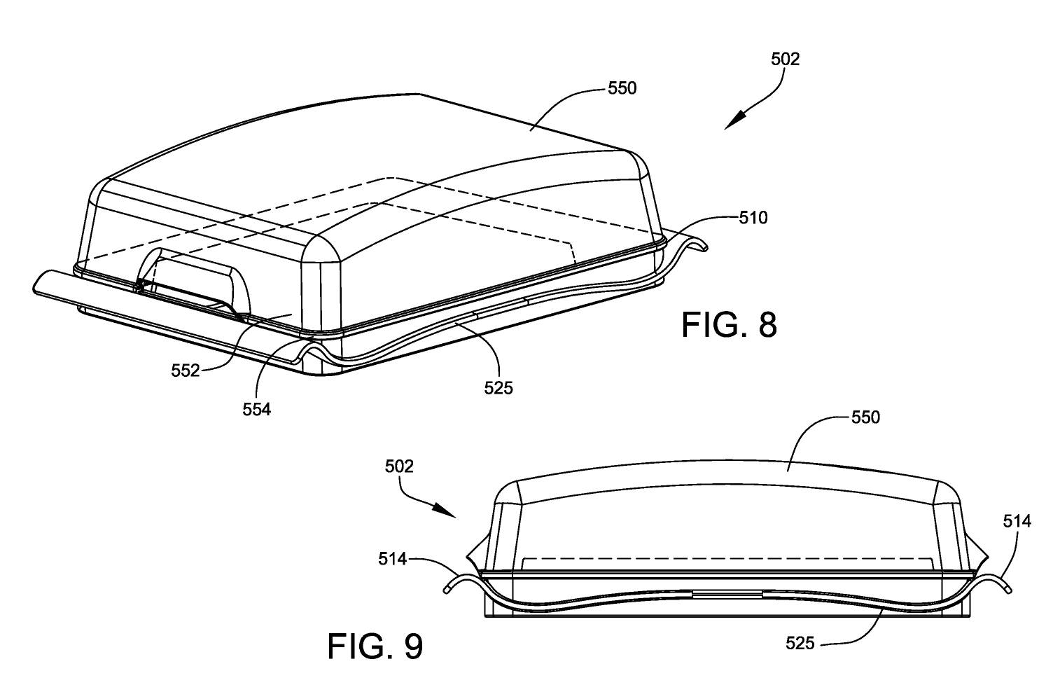

FIG. 8 shows a perspective view of a cover of the preferred embodiment of FIG. 5. FIG. 9 shows a side view of a preferred embodiment of FIG. 8. Preferably, the cutting board and serving tray 502 comprises a cover 550, preferably a removable cover 550, as shown. Preferably, a bottom edge 552 of cover 550 couples with at least one edge 554 of third surface 510 so that the cover 550 may provide a seal between the respective bottom edge 552 and edge 554, as shown. Preferably, the cover 550 provides a cover 550 for the cutting surface for eventual use as a serving tray and/or for storage of food after serving. Upon reading this specification, those with ordinary skill in the art will now appreciate that, under appropriate circumstances, considering such issues as design preferences, marketing, cost, structural requirements, available materials, etc., other cover arrangements such as, for example, split covers, covers supported by the peripheral edge, smaller covers, etc., may suffice. Preferably, the cover 550 comprises two handles 560, preferably for assisting lifting of the cover 550 off of the tray 502, as shown.

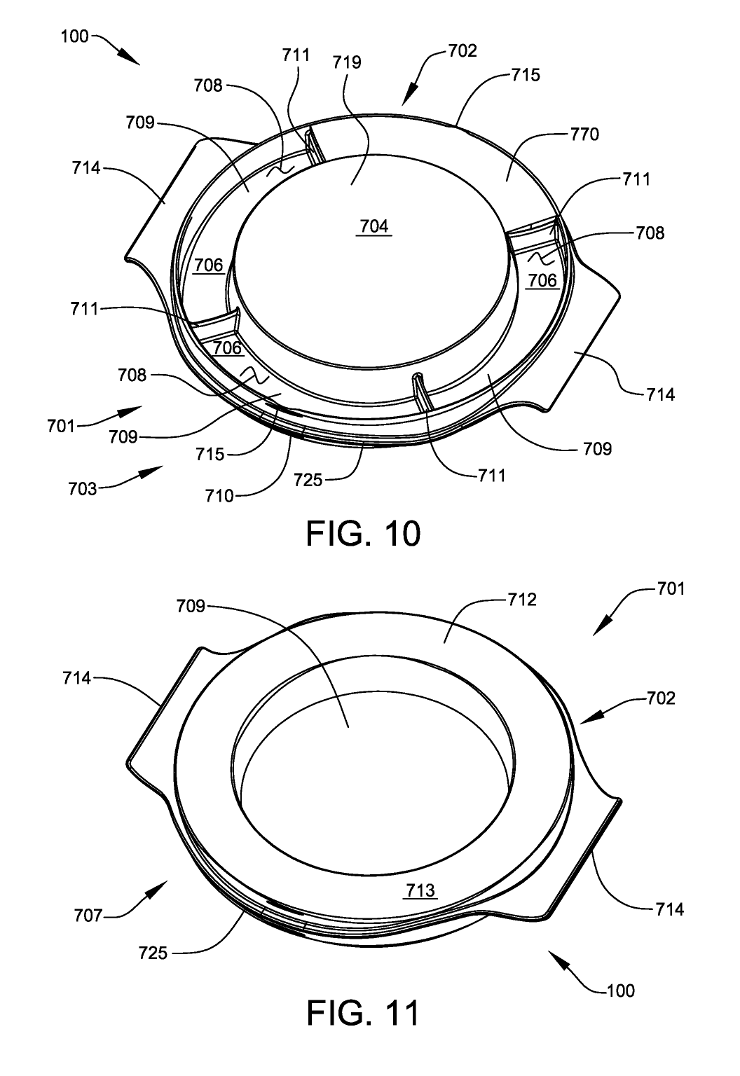

FIG. 10 shows a perspective view, illustrating the top side 703 of another cutting/serving tray of the tray system 100, according to another preferred embodiment 701 of the present invention.

Preferably, embodiment 701 comprises a combination cutting board and serving tray 702, as shown. Preferably, cutting board and serving tray 702 comprises three separate surface heights, as shown and described further herein. Preferably, cutting board and serving tray 702 comprises a first surface 704, preferably the largest surface, preferably centrally located and situate in the highest elevation of the three surfaces, as shown. Preferably, first surface 704 is substantially flat and provides a surface for cutting usable as a cutting surface for cutting foods with a knife. Preferably, the first surface 704 also comprises a texture 719, preferably dimpled and or textured, preferably assisting gripping of items to be cut and, preferably assisting maintaining a clean look for the first surface even after multiple uses cutting on the surface.

Preferably, first surface 704 may also be utilized as a serving surface for serving food, as shown. Upon reading this specification, those with ordinary skill in the art will now appreciate that, under appropriate circumstances, considering such issues as user preferences, marketing preferences, cost, structural requirements, available materials, etc., other serving tray arrangements such as, for example, use of the cutting board area for serving whether the food was cut on the board or not, etc., may suffice.

Preferably, cutting board and serving tray 702 comprises a second surface 706, preferably below the first surface 704, as shown. Preferably, the second surface 706 is the bottom of a channel 708, preferably, the lowest elevation, preferably circumferential to the first surface 704, as shown. Preferably, channel 708 assists with the collection of fluid and food that may occur during cutting or preparation of food on the first surface 704 (cutting surface), as shown. Additionally, the channel 708 is preferably compartmentalized into individual compartments 709, preferably quartered, as shown. As such, channel 708 may also be used for holding food such as, for example, condiments, dip, vegetables, etc., when used as a serving dish. Preferably, each respective compartment 709 is separated from each other respective compartment 709 by dividing wall elements 711, as shown. Preferably, compartments 709 may be used to hold different fluid elements or different food elements that may be served with the cutting board and serving tray 702. Upon reading this specification, those with ordinary skill in the art will now appreciate that, under appropriate circumstances, considering such issues as user preferences, marketing preferences, cost, structural requirements, available materials, etc., other fluid collection arrangements such as, for example, multiple fluid channels, serpentine fluid channels, drain holes, etc., may suffice.

Preferably, at least one, highly preferably two compartments 709 further comprises a fluid pour spout 715, as shown. Preferably, fluid pour spouts on the circular embodiment 701 are located about midway between each respective handle 714, as shown. When the cutting board and serving tray 702 is circular, the fluid pour spout 715 is preferably centered in the compartment 709. Preferably, the fluid pour spout has a radius of about one inch, as shown. Preferably, the fluid pour spout 715 is located in the corners 715 of the compartments 709 when the cutting board and serving tray 702 is rectangular in shape, as shown. Upon reading this specification, those with ordinary skill in the art will now appreciate that, under appropriate circumstances, considering such issues as user preferences, marketing preferences, cost, structural requirements, available materials, etc., other pour spout arrangements such as, for example, off center, smaller or larger radiuses, etc., may suffice.

Preferably, cutting board and serving tray 702 comprises a third surface 710, preferably peripheral to the second surface 706, preferably acting as a fluid blocker/material retainer to assist retaining fluid and material within the channel 708, as shown. Preferably, third surface 710 also acts as a decorative edge for the cutting board and serving tray 702. Preferably, the third surface 710 is situate at an intermediate elevation to the first surface 704 and the second surface 706, as shown. Preferably, the third surface 710 is below the first surface 704 so that as a user cuts in a normal fashion perpendicular to the cutting surface along the first surface 704, a knife blade does not come into contact with the third surface 710. Preferably, the distance in elevation between the first surface 704 and the third surface 710 is between about one-eighth inch and about one-inch. Upon reading this specification, those with ordinary skill in the art will now appreciate that, under appropriate circumstances, considering such issues as design preferences, structural requirements, available materials, geographic location, etc., other elevations between the first surface (cutting) and third surface (peripheral edge) may suffice.

FIG. 11 shows a perspective view illustrating the bottom side 707 of the cutting/serving tray according to the preferred embodiment of FIG. 10.

Preferably, cutting board and serving tray 702 comprises a bottom side 707 that may also be utilized as a serving dish. Preferably, bottom side 707 comprises at least one bowl portion 709, preferably being the underside of the first surface 704, as shown. Preferably, bottom side 707 comprises support surface 712, most preferably having at least one bottom surface 713 that will flatly support the cutting board and serving tray 702, when placed for use of the top side 703, and keep the top side 703 of cutting board and serving tray 702 level during use. Upon reading this specification, those with ordinary skill in the art will now appreciate that, under appropriate circumstances, considering such issues as cost, structural requirements, available materials, etc., other bottom supports structures using materials such as, for example, legs, rails, bumps, etc., may suffice.

Preferably, the cutting board and serving tray 702 comprises two handles 714, as shown. Preferably, intermediate and connected to the two handles 714 are edging elements 725, preferably serpentine edging elements, as shown. Preferably, edging elements 725 assists a user in positioning the cutting board and serving tray 702, catch fluid that may drip when serving, and provide a decorative edge, as shown.

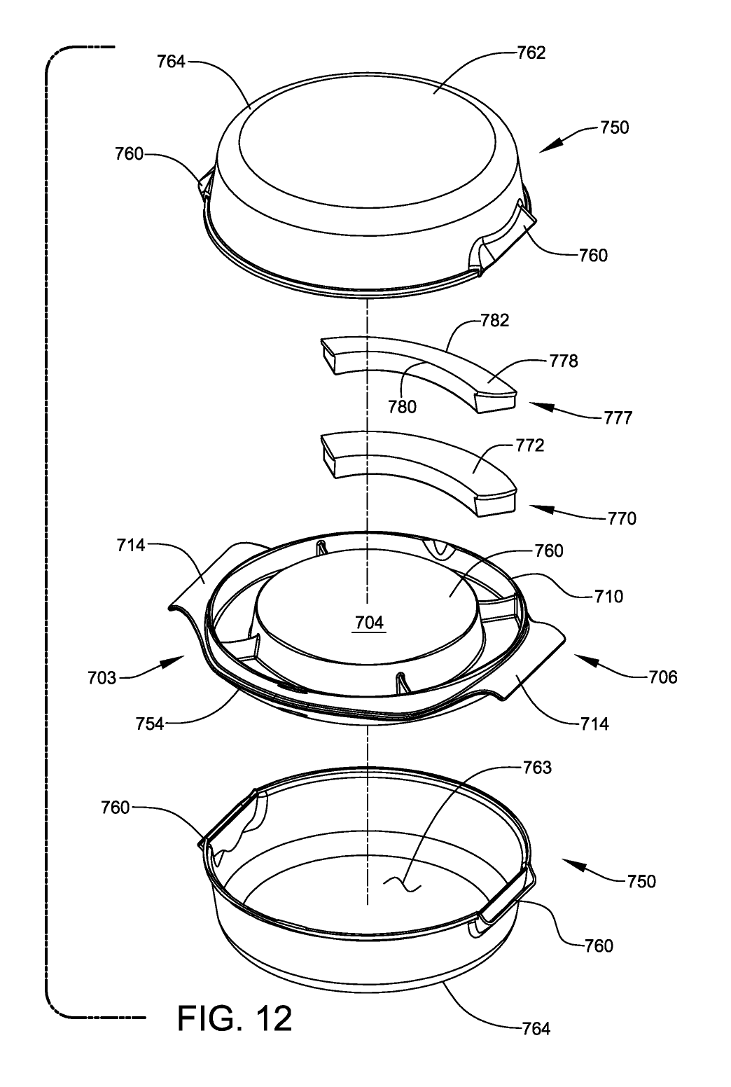

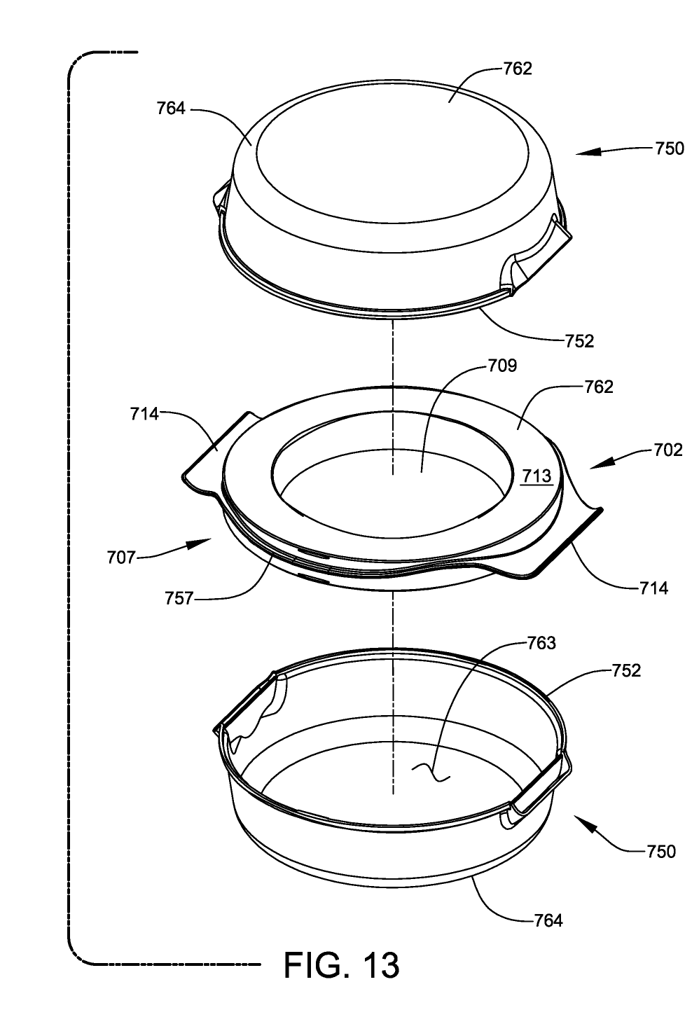

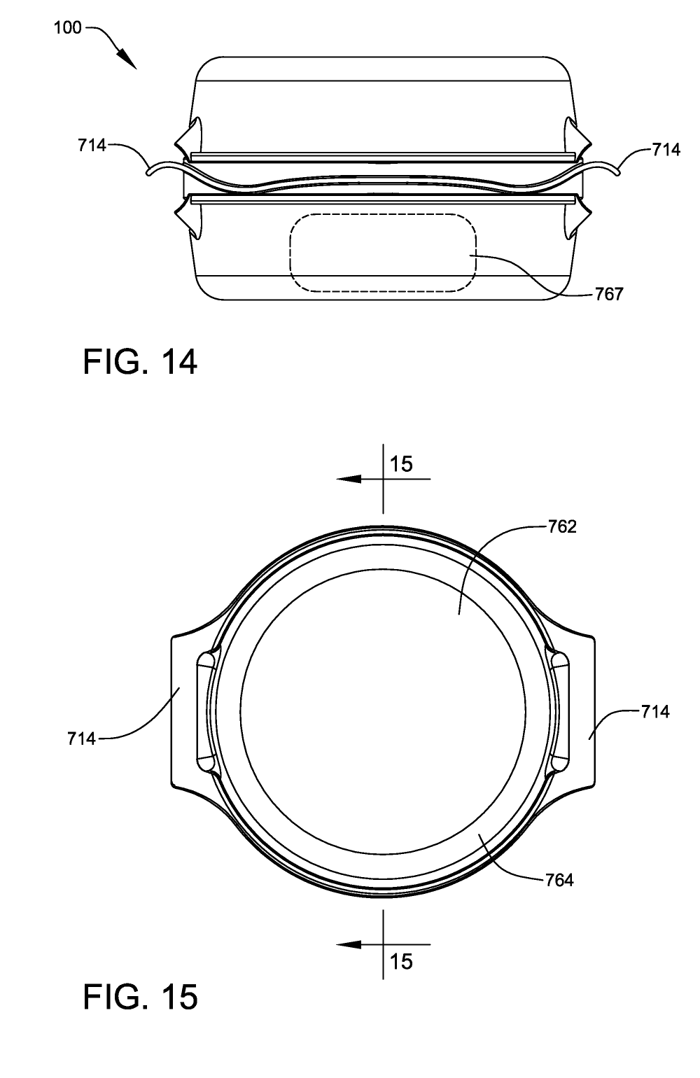

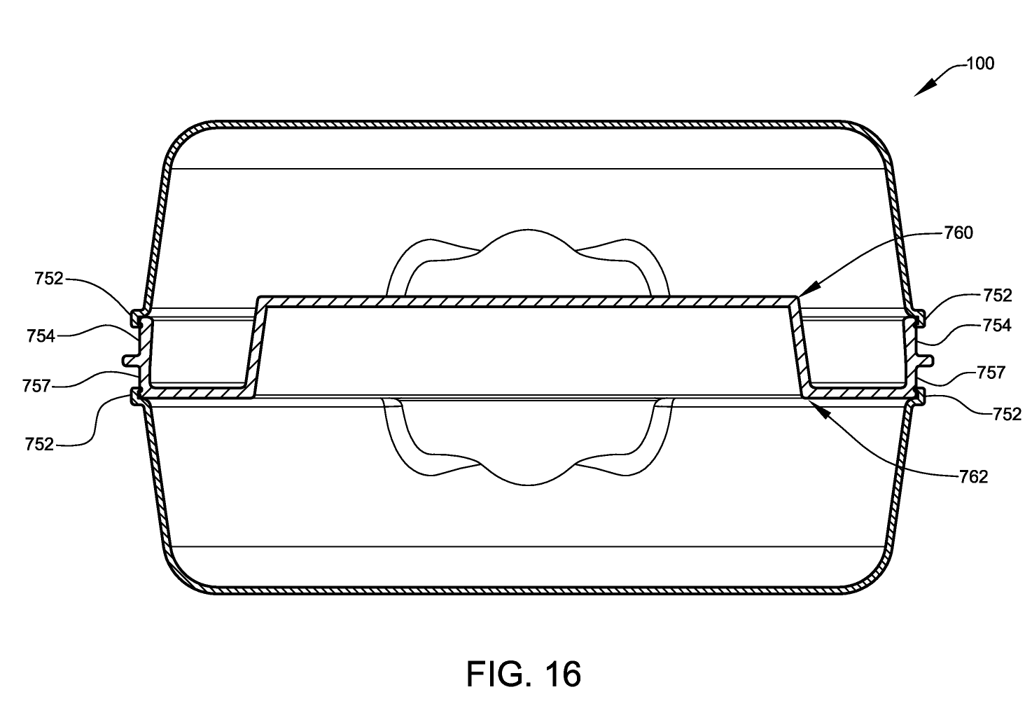

FIG. 12 shows an exploded perspective view, utilizing cover 750 of the cutting/serving tray, according to the preferred embodiment 703 of FIG. 10. FIG. 13 shows an exploded perspective view, of cover 750 of the cutting/serving tray, according to the preferred embodiment 707 of FIG. 11. FIG. 14 shows a side view, illustrating the cutting/serving tray, according to the preferred embodiment of FIG. 12. FIG. 15 shows a top view, illustrating the cutting/serving tray, according to the preferred embodiment of FIG. 14. FIG. 16 shows a sectional view through section 15-15 of FIG. 15.

Preferably, the cutting board and serving tray 702 comprises at least one cover 750, preferably a removable cover 750, as shown [two covers 750 may be provided as shown in FIG. 14]. However, even though two covers 750 are shown, it is also preferred that a single cover 750 may be used to cover the cutting board and serving tray 702 on either top side 760 (FIG. 12) or bottom side 762 (FIG. 13) of the cutting board and serving tray 702. Preferably, a bottom edge 752 of cover 750 may be coupled with at least one edge 754 (top side 760) or 757 (bottom side 762), highly preferably a groove circumferential along both edge 754 (top side 760) and edge 757 (bottom side 762) so that the cover 750 may provide a tight seal between the respective bottom edge 752 and edges 754/757, as shown. Preferably, the cover 750 may be used for multiple purposes. Preferably, cover 750 provides a cover for the cutting surface for eventual use as a serving tray and/or for storage of food after serving. Preferably, cover 750 may be placed onto the bottom side 762 of the cutting board and serving tray 702 so that it supports the cutting board and serving tray 702 and provides a space 763 wherein a heating or cooling element 767 (See FIG. 14) may be placed, such as, for example, ice to keep cold food cold or reduce spoiling of items that need to maintain a given temperature or heat to maintain the contents placed onto the top side 760 warm. Upon reading this specification, those with ordinary skill in the art will now appreciate that, under appropriate circumstances, considering such issues as design preference, user preferences, marketing preferences, cost, structural requirements, available materials, technological advances, etc., other inverted cover arrangements such as, for example, use as a bowl, use to hold other food, etc., may suffice.

Preferably, cover 750 comprises a flat top surface 762 with a substantially rigid outer periphery 764 to add rigidity and strength to cover 750 and being structured so as to support the weight of the cutting board and serving tray 702 when the cover 750 is used underneath the cutting board and serving tray 702, as shown. Upon reading this specification, those with ordinary skill in the art will now appreciate that, under appropriate circumstances, considering such issues as design preferences, marketing, cost, structural requirements, available materials, etc., other cover arrangements such as, for example, split covers, covers supported by the peripheral edge, smaller covers, etc., may suffice. Further, upon reading this specification, those with ordinary skill in the art will now appreciate that, under appropriate circumstances, considering such issues as design preference, user preferences, marketing preferences, cost, structural requirements, available materials, technological advances, etc., other cover stiffening arrangements for assisting cover support such as, for example, ribbing, stiffer materials, honeycombing, thicker material, etc., may suffice.

Preferably, the cover 750 comprises two handles 760, preferably for assisting lifting of the cover 750 off of the tray 702 as shown. Preferably, such handles 760 are ergonomically formed, preferably having a slight serpentine for assisting hand grasping from both useful positions on either top side 760 (FIG. 12) or bottom side 762 (FIG. 13).

Preferably, tray system 100 further comprises at least one filler block 770, as shown. Preferably, filler block 770 is made to fit tightly within at least one compartment 709 of the top side 760 of the cutting board and serving tray 702, as shown. Preferably, the filler block 770 comprises a flat upper surface 772 structured and arranged to be flush with the first surface 704 and extend to the third surface 710 or at least to the periphery of the cutting board and serving tray 702 so as to assist material cut on the cutting portion to be easily moved off of the cutting portion without dropping into a compartment 709. Preferably, filler block 770 assists moving such material onto another serving dish or to a sink or other such device. Even further, filler block 770 preferably increases the surface area of the cutting surface when utilized. In another preferred embodiment of the filler block 770, a filler block 777 may be utilized that has a tapered top 778 so that one end portion 780 is the same height as the first surface 704 (cutting surface) and the opposing end portion 782 is about the same height as the third surface 710 (peripheral edge). Upon reading this specification, those with ordinary skill in the art will now appreciate that, under appropriate circumstances, considering such issues as design preference, user preferences, marketing preferences, cost, structural requirements, available materials, technological advances, etc., other filler block arrangements such as, for example, smaller or larger dimensions, overhanging portions, juice portions, knife holding portions, utensil holding portions, etc., may suffice.

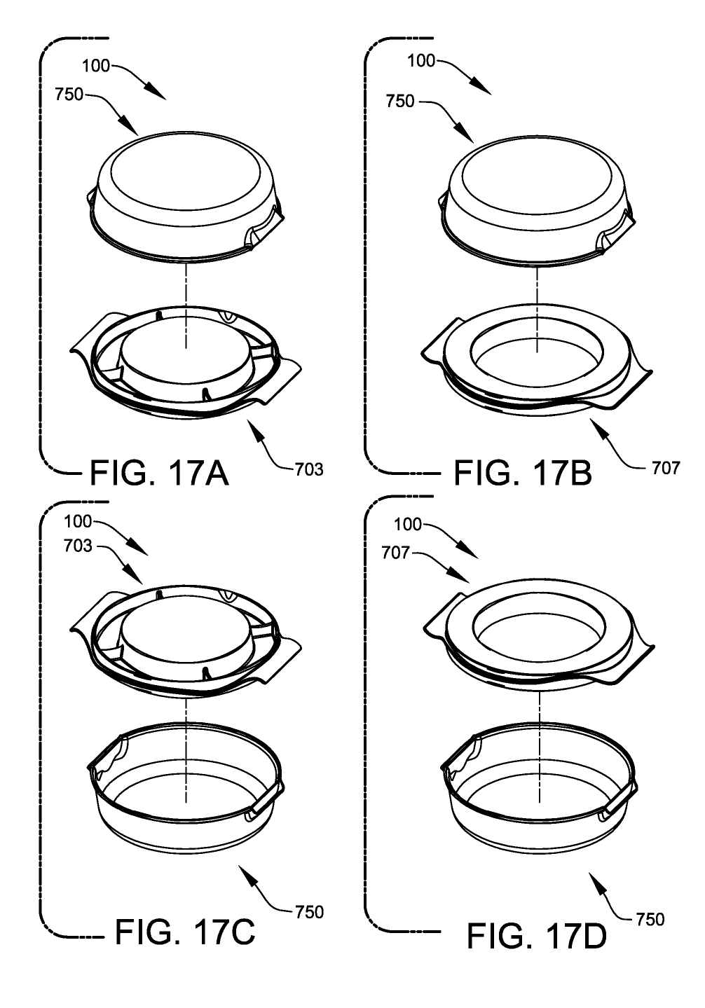

FIG. 17A, FIG. 17B, FIG. 17C and FIG. 17D show perspective views, of at least a 4-way use of the cutting/serving tray according to the preferred embodiment of the present invention described above. As described above, and referenced in FIG. 17A, FIG. 17B, FIG. 17C and FIG. 17D, the tray systems 100 preferably comprise at least a 4-way combination use of the cutting board and serving tray 702 and cover 750,as shown. Preferably, the 4-way combination at least includes: at least one combination wherein the lower piece serves as a tray and the upper piece serves as a tray cover; at least one combination wherein the upper piece serves as a bowl and the lower piece serves as an ice container; at least one combination wherein the lower piece serves as a bowl and the upper piece serves as a bowl cover; and at least one combination wherein the upper piece serves as a tray and the lower piece serves as an ice container. Upon reading this specification, those with ordinary skill in the art will now appreciate that, under appropriate circumstances, considering such issues as design preference, user preferences, marketing preferences, cost, structural requirements, available materials, technological advances, etc., other combination-use arrangements such as, for example, utilizing more than one such cutting board and serving tray in combination, use of covers for serving functions, decorated themed covers, knife holding portions, colored portions, other functions added to the cutting board and serving tray, etc., may suffice.

Further, the 4-way combination preferably comprises wherein each at least four different-use combinations comprise: at least one combination wherein the at least one upside tray serves as a tray and the at least one tray cover serves as a tray cover; at least one combination wherein the at least one inverted tray serves as a bowl and the at least one tray cover serves as an ice container; at least one combination wherein the at least one inverted tray serves as a bowl and the at least one tray cover serves as a bowl cover; and at least one combination wherein the at least one upside tray serves as a tray and the at least one tray cover serves as an ice container. Upon reading this specification, those with ordinary skill in the art will now appreciate that, under appropriate circumstances, considering such issues as design preference, user preferences, marketing preferences, cost, structural requirements, available materials, technological advances, etc., other combinations and arrangements such as, for example, utilizing more than one such cutting board and serving tray in combination, use of covers for serving functions, decorated themed covers, knife holding portions, colored portions, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A tray comprising:
a) at least one first surface;
b) at least one second surface;
c) at least one third surface; and
d) at least one support surface;
e) wherein said at least one first surface is centrally located and situate at a highest elevation;
f) wherein said at least one second surface is circumferential to said at least one first surface and situate at a lowest elevation;
g) wherein said at least one third surface is peripheral to said at least one second surface and situate at an elevation intermediate to elevations of said at least one first surface and said at least one second surface; and
h) wherein said at least one support surface is structured and arranged to support said at least one first surface in a substantially flat position.

2) The tray according to claim 1 wherein:
a) said at least one first surface permits slicing;
b) said at least one second surface permits collection of at least one fluid; and
c) said at least one third surface permits retaining of such at said at least one fluid.

3) The tray according to claim 1 wherein said at least one second surface comprises at least one channel structured and arranged to collect at least one material.

4) The tray according to claim 2 wherein the elevation difference between said at least one first surface and said at least one third surface is at least about one-eighth inch and not more than about two inches.

5) The tray according to claim 2 wherein at least one periphery of said tray is substantially rectangular.

6) The tray according to claim 5 wherein said tray comprises HDPE plastic.

7) The tray according to claim 3 wherein said at least one channel further comprises at least one divider structured and arranged to divide said at least one channel into at least two channel portions.

8) The tray according to claim 2 wherein said at least one channel comprises at least one pour spout structured and arranged to assist fluid removal from at least one of said at least one channel.

9) The tray according to claim 2 further comprising at least one handle.

10) The tray according to claim 2 wherein at least one periphery of said tray is substantially circular.

11) The tray according to claim 2 further comprising:
a) at least one lid;
b) wherein said at least one lid is supportable by said at least one second surface.

12) The tray according to claim 2 further comprising:
a) at least one lid;
b) wherein said at least one tray is supportable by said at least one lid.

13) The tray according to claim 11 wherein said at least one lid is structured and arranged to cover at least one portion of said at least one first surface.

14) The tray according to claim 9 wherein said at least one handle comprises two such handles, one such handle opposed, with respect to said at least one support surface, to another such handle.

15) The tray according to claim 14 wherein said at least two handles comprise at least one serpentine connection edge intermediate of said at least two handles.

16) The tray according to claim 2 wherein said at least one first surface is substantially flat.

17) The tray according to claim 16 wherein said tray is structured and arranged so that a knife edge in place to slice upon said at least one first surface will not normally contact other portions of said tray.

18) The tray according to claim 7 further comprising at least one channel filler structured and arranged to fill at least one said at least one channel.

19) The tray according to claim 1 wherein when said tray is inverted, said inverted tray comprises:
a) inverted said at least one first surface;
b) inverted said at least one second surface; and
c) inverted said at least one third surface;
d) wherein said at least one inverted first surface is centrally located and situate at a lowest elevation;
e) wherein said at least one inverted second surface is circumferential to said at least one inverted first surface and situate at a highest elevation;
f) wherein said at least one inverted third surface is peripheral to said at least one inverted second surface and situate at an elevation intermediate to elevations of said at least one inverted first surface and said at least one inverted second surface; and
g) wherein said at least one inverted first surface is structured and arranged to support said inverted tray in a substantially flat position.

20) The tray according to claim 19 further comprising: at least one tray cover structured and arranged to couple to said tray whether upside or inverted.

21) The tray according to claim 20, wherein:
a) said tray may be used as at least one upside tray or at least one inverted tray; and
b) by snap-connecting, at least four different-use combinations of said at least one tray and said at least one tray cover are thereby provided.

22) The tray system according to claim 23 wherein such at least four different-use combinations comprise:
a) at least one combination wherein the at least one upside tray serves as a tray and the at least one tray cover serves as a tray cover;
b) at least one combination wherein the at least one inverted tray serves as a bowl and the at least one tray cover serves as an ice container;
c) at least one combination wherein the at least one inverted tray serves as a bowl and the at least one tray cover serves as a bowl cover; and
d) at least one combination wherein the at least one upside tray serves as a tray and the at least one tray cover serves as an ice container.

23) A method of using at least one tray, comprising at least one highest-elevation central cutting board portion, at least one lowest-elevation fluid-holdable channel portion, and at least one intermediate-elevation peripheral surface, comprising the steps of:
a) situating sliceable food on the cutting board portion;
b) using at least one knife to slice the food;
c) arranging the food for presentation, wherein any fluids may collect in the channel portion; and
d) carrying the tray with the food to at least one serving location.

24) A tray system, relating to providing at least one 2-piece tray ensemble comprising at least one tray piece and at least one tray-cover piece, wherein:
a) each such at least one piece may be used upside or inverted; and
b) by snap-connecting, at least four different-use combinations of such pieces are thereby provided.

25) The tray system according to claim 25 wherein such at least four different-use combinations comprise:
a) at least one combination wherein the lower piece serves as a tray and the upper piece serves as a tray cover;
b) at least one combination wherein the upper piece serves as a bowl and the lower piece serves as an ice container;
c) at least one combination wherein the lower piece serves as a bowl and the upper piece serves as a bowl cover; and
d) at least one combination wherein the upper piece serves as a tray and the lower piece serves as an ice container.
